(19) United States
(12) Patent Application Publication
(10) Pub. No.: US 2007/0244691 A1
(43) Pub. Date: Oct. 18, 2007

(54) Translation of user interface text strings

(75) Inventors: Antonio M. Alwan, Bothell, WA (US); Gurinder Singh, Renton, WA (US); Sachin G. Karnik, Sammamish, WA (US); Soohad M. Khoury, Redmond, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/406,210

(22) Filed: Apr. 17, 2006

(51) Int. Cl. G06F 17/20

(52) U.S. Cl. 704/8

(57) ABSTRACT

Described are methods of translating text strings displayed by a user interface application in a source language into text strings in a target language. A translator application creates a dynamic database file containing a mapping of source language text strings to corresponding target language text strings. When a request to translate a source language text string is received, the translator application retrieves a corresponding target language text string from the dynamic database file and displays the target language text string, while the source language text string is also being displayed by the user interface application.

### BACKGROUND

Many software applications are developed for use in a number of countries. If the application is a user interface application, the text strings displayed to a user must be in a user's native language. For example, the text strings displayed on menus, buttons and taskbars should be in a language that the user can understand. For this reason, before being shipped out to a specific country or region an application is usually “localized,” meaning modified for a particular country or region, including translating text strings.

However, even if a user interface application has been localized for a country or region, a particular user may want to translate the text strings displayed by the application. In one example of this, a user may have learned an application using a nonlocalized version of the application. Although the localized version may be in the user's native language, they may still prefer the nonlocalized version that they are accustomed to using.

There are some software programs available for translating text strings displayed by user interface applications. However, typically the available software programs translate all the text strings displayed by a user interface application form one language into a second language. A user cannot therefore select specific text strings to translate. Moreover, current software programs do not provide for allowing the display of text strings in two languages.

It is with respect to these and other considerations that the present invention has been made. Also, although relatively specific problems have been discussed, it should be understood that embodiments of the present invention should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

In embodiments, the present invention provides for translating text strings displayed by a user interface application in a source language into target language text strings. The translating is performed using a dynamic database file created using resource files. The resource files are files that are used by the user interface application to localize the user interface application in a particular language. The dynamic database file is created by extracting source language text strings and target language text strings from resource files, and mapping the source language text strings to corresponding target language text strings. After the database is created, text strings in a source language may be translated by retrieving the target language text string mapped to the source language text string. This allows a user to select a specific text string to translate.

The present invention provides, in some embodiments, for displaying a text string with its translation. A user selects a text string that is in a source language to translate. A translation is then displayed with the source language text string. This aspect of the present invention allows a user to see text strings and their translations at the same time.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a software environment for implementing aspects of the present invention.

FIG. 2 is a block diagram illustrating a computing environment suitable for implementing aspects of the present invention.

FIG. 3 illustrates a screen displayed by a user interface application that includes a text string in a source language and a translation of the string into a target language.

FIG. 4 illustrates a screen displayed by a user interface application that includes a text string in a source language and a translation of the string into a target language.

FIG. 5 illustrates an operational flow for creating a dynamic database file.

FIG. 6 illustrates an operational flow for translating a text string displayed by a user interface application.

FIG. 7 illustrates an operational flow for displaying a text string and a translation of the text string.

### DETAILED DESCRIPTION

Various embodiments are described more fully below with reference to the accompanying drawings, which form a part hereof, and which show specific embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

In embodiments, the present invention provides for translating text strings displayed by a user interface application in a source language to text strings in a target language. Throughout the description, the term “source language” is used to refer to a language in which the text strings are displayed by a user interface application. The language may be any language (e.g., Hindi, English, Spanish, German, French, etc.). The term “target language” is used to refer to a language into which the text strings are translated. The language may also be any language (e.g., Hindi, English, Spanish, German, French, etc.).

In some cases, a user interface application includes resource files that allow the application to be localized in a number of languages. The resource files are installed when the application is installed, and contain those portions of an application that are localized. As one example, the resource files include the text strings displayed by the user interface application on menus, dialog boxes, and buttons. An application may support a number of languages each with its own resource file. Accordingly, a user chooses one language from the languages supported by the user interface application. At runtime, the specific resource file corresponding to the chosen language will be used by the application to localize the application. A user may later change the language preferences to another language, in which case at runtime the application will use the resource file corresponding to the other language. However, only one language at a time may be selected to localize the application. In some embodiments, the present invention takes advantage of the presence of the resource files in user interface applications to translate text strings from a source language to a target language.

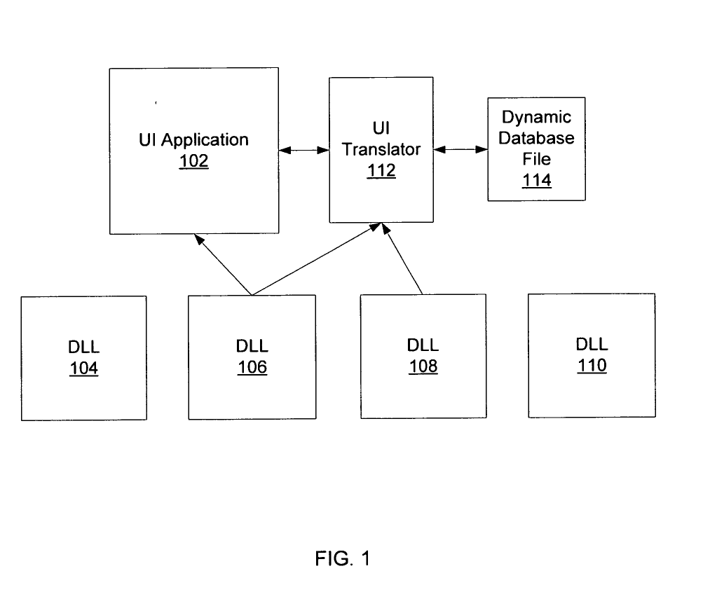

FIG. 1 illustrates an software environment 100 for creating a dynamic database file, which may be used in translating text strings displayed by a user interface application, according to one embodiment of the present invention. In this embodiment, system 100 includes a user interface (UI) application 102 that may be localized in four languages using four resource files, which are in the form of dynamic link libraries (DLLs) 104, 106, 108 and 110. The system also includes a user interface (UI) translator 112, which creates dynamic database file 108 using information from DLLs 104, 106, 108 and/or 110, and translates text strings displayed by UI application 102.

UI application 102 may be any application including, but not limited to, a word processor, spreadsheet, database, electronic mail, application etc., that has a graphical user interface for allowing a user to interact with the application. As part of the graphical user interface, UI application displays a number of text strings, such as text strings on menus, dialog boxes, taskbars, and buttons. DLLs 104, 106, 108 and 110 contain the necessary information for localizing UI application 102 in four different languages. As part of the information for localizing UI application 102, DLLs 104, 106, 108 and 110 include text strings displayed by UI application 102. In some embodiments, DLLs 104, 106, 108 and 110 store the text strings displayed by application 102 in association with resource ID numbers. As one simplified example, resource ID number 1 may be associated with the text string “Tools.” Accordingly, in each DLL, the resource ID number 1 will be associated with a text string that conveys the same meaning as “Tools” in each of the four languages for which UI application 102 may be localized.

As shown in FIG. 1, UI application 102 is localized using DLL 106, which for purposes of illustration will be referred to as localizing UI application 102 in Hindi. Accordingly, in this embodiment DLL 106 includes resource ID numbers associated with text strings in Hindi that are displayed in menus, dialog boxes, etc., by UI application 102.

In accordance with an embodiment of the present invention, UI translator 112 is an application or software module that is programmed to access resource files such as DLLs 104-110 to generate a dynamic database file 114, which is then used by UI translator 112 to translate text strings displayed by UI application 102, as described in greater detail below. UI translator 112 accesses two resource files and extracts information from the resource files to create dynamic database file 114. Dynamic database file 114 contains a mapping of text strings in one language (source language) to corresponding text strings in a second language (target language). To create the dynamic database file 114, UI translator 112 uses the resource ID numbers associated with the text strings stored in DLLs 104, 106, 108, and 110. For example, UI translator 112 will use resource ID number 1, which may be associated with the text strings that conveys the meaning “Tools,” to map the text strings in one DLL to the corresponding text strings in a second DLL, both of which are associated with the resource ID number 1.

In the example shown in FIG. 1, UI translator 112 accesses DLLs 106 and 108. For purposes of illustration, DLL 108 will be described as containing information for localizing UI application 102 in English. UI translator 112 accesses DLL 106, retrieves the resource ID numbers and the text strings in Hindi associated with the resource ID numbers, and stores the information in the dynamic database file 114. The translator 112 then accesses DLL 108 to retrieve the resource ID numbers and the text strings in English associated with the resource ID numbers, and stores the English text strings and resource ID numbers in the dynamic database file 114.

Translator 112 then maps the Hindi text strings to corresponding text strings using the resource ID numbers associated with the Hindi text strings with the English text strings. As a result, UI translator 112 builds the dynamic database file 114 to include resource ID numbers stored in association with text strings in Hindi and corresponding text strings in English. By building dynamic database file 114 as described, translating text strings in Hindi to text strings in English can be performed by simply looking up the Hindi text strings and retrieving the associated English text strings.

After dynamic database file 114 is created by UI translator 112, it may be used to translate text strings displayed by UI application 102 from Hindi to English, during runtime of UI application 102. UI application 102 has a graphical user interface for allowing a user to use and control operation of UI application 102. UI application 102 is installed on a computer system that includes a display and a user interface selection device, e.g., a mouse, touch pad or pen, for controlling the movement of a pointer displayed on the display. The pointer is used to perform actions in UI application 102. For example, if UI application 102 is menu driven, a user may control the pointer with a mouse to select menus and tasks listed within the menus to control operation of UI application 102.

As previously stated, UI application 102 displays text strings in menus, dialog boxes, and task bars. UI translator 112 is used to translate the text strings, and in one embodiment displays the translated text strings in small pop-up boxes. In this embodiment, a user uses the mouse to control the pointer on the display. When the pointer is hovered on or near a Hindi text string displayed by UI application 102, a small pop-up box appears near the pointer and displays the translated text string in English. In some embodiments, the pop-up box may display the Hindi text string followed by the English text string. In other embodiments, the pop-up box may simply display the English text string.

An example of operation of system 100, according to one embodiment, is described below. The following description is made with respect to translating Hindi text strings displayed by UI application 102 into English text strings, however this description applies to translating any source language text string to any target language text string. During runtime of UI application 102, a user positions the pointer on or near a text string that is in Hindi. UI translator 112 receives a signal or message that the pointer is on or near a text string. In one embodiment, UI application 102 captures the Hindi text string, and sends the text string with the signal or message. In other embodiments, it is the UI translator 112 that captures the Hindi text string. UI translator 112 will use the received Hindi text string to search in dynamic database 114 to retrieve the English text string.

Searching and retrieving the English text string from database 114 may occur in a variety of ways. In one embodiment, UI translator 112 compares the Hindi text string against a list of Hindi text strings in database 114. When a matching text string is found, the corresponding resource ID number associated with the matching text string is identified. The resource ID number is then used to locate the English text in dynamic database 114. The UI translator 112 then retrieves the English text string, opens a small pop-up box, and displays the English text string in the small pop-up box.

As a specific example of this operation, a user may position the pointer next to a menu item that displays the Hindi text string for “Tools.” UI application 102 will capture the string and send the string to UI translator 112. UI translator 112 will compare the Hindi text string to the list of Hindi text strings in dynamic database 114. When a match is made, UI translator 112 identifies the associated resource ID number stored with the matched Hindi text string. The resource ID number is used to identify and retrieve the English text string “Tools.” UI translator 112 opens a pop-up box near the pointer and displays the text string “Tools.”

Although system 100 has been described with respect to specific embodiments such as translating text strings from Hindi to English, it will be appreciated by those with skill in the art that system 100 may be used to translate text strings from any source language to any target language. Moreover, although system 100 has been described with specific files and applications, such as dynamic database 114, in some embodiments system 100 may include additional parts such as two dynamic databases, each mapping text strings in a different source language to text strings in a different target language. In yet other embodiments, system 100 may be implemented using fewer components, for example instead of having a dynamic database 114, in some embodiments UI translator 112 may extract information from the DLLs 104, 106, 108 and 110 each time a string of text must be translated.

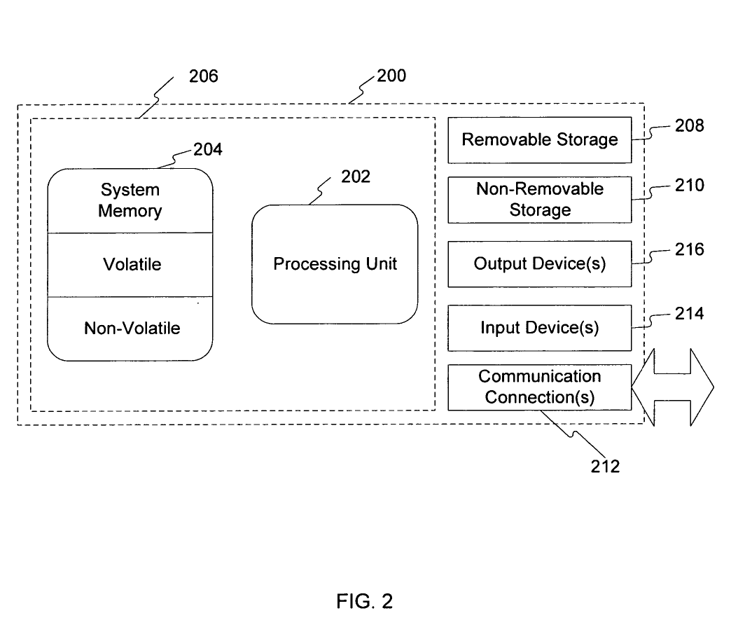

FIG. 2 illustrates a general computer environment 200, which can be used to implement the embodiments described herein. The computer environment 200 is only one example of a computing environment and is not intended to suggest any limitation as to the scope of use or functionality of the computer and network architectures. Neither should the computer environment 200 be interpreted as having any dependency or requirement relating to any one or combination of components illustrated in the example computer environment 200.

In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

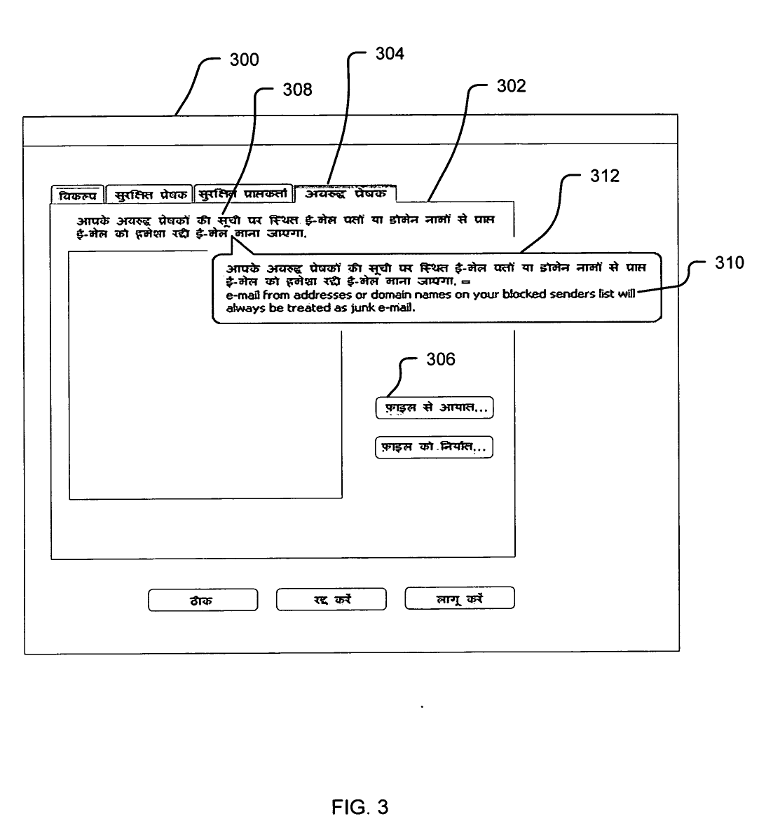

FIG. 3 illustrates a screen 300 with text strings in Hindi, one of which is translated into English according to one embodiment of the present invention. FIG. 3 shows a screen 300 that may be displayed by a UI application. In FIG. 3, the UI application is localized in Hindi, and thus displays text strings in Hindi. Screen 300 shows a dialog box 302, associated with an active tab 304. Dialog box 302 includes a number of buttons such as button 306 with text strings in Hindi. Additionally, dialog box 302 includes a text string 308 that is also in Hindi. Text string 308 is translated from Hindi to English as shown in FIG. 3 using a translator application, such as UI translator 112 described above with respect to FIG. 1. The English text string 310 is displayed within a pop-up box 312.

According to one embodiment of the present invention, a user may have translated any of the text strings that are displayed on screen 300, or otherwise displayed by the UI application, into a pre-selected target language. In the embodiment shown in FIG. 3, a user has selected to have the text strings translated from Hindi to English. When a user wants to have a specific text string translated, the user simply moves a pointer with a mouse to hover on or near the text string to translate. In FIG. 3, a user has hovered a pointer on or near text string 308. As a result, a translator application, according to an embodiment of the present invention, has translated text string 308 from Hindi to English, and displayed the English text string 310 in pop-up box 312. In the embodiment shown in FIG. 3, pop-up box 312 displays the Hindi text string 308 first, followed by an equal sign and then English text string 310. In other embodiments, the translator application may simply display the English text string 310 in pop-up box 312.

As will be appreciated by those of skill in the art, the use of a pointer and pop-up box 312 is only one way for a translator to display translated text strings. In other embodiments, translated text strings may be displayed in a variety of different ways. In one embodiment, a translator may simple replace Hindi text string 308 with English text string 310, when a user hovers a pointer over Hindi text string 308. In yet other embodiments, when a user hovers the pointer over Hindi text string 308, a translator application may display an equal sign and English text string 310 in a location immediately following Hindi text string 308, instead of opening pop-up box 312.

A translator application may also trigger the translation of text strings in a variety of ways. As stated above, in some embodiments, hovering a pointer controlled by a mouse on or near a text string may trigger the display of a translated text string. In other embodiments, a user must not only hover the pointer over a text string, but must also perform an additional action such as pressing a button, i.e., night or left click on a mouse; or pressing a key on a keyboard (e.g., control, shift, Alt, a function key, etc.).

In yet other embodiments, a single action may trigger the display of translations of a number of text strings currently displayed on a screen. For example, referring again to FIG. 3, a translation application may be programmed so that when a user presses a combination of keys on a keyboard, or right clicks on a mouse, it displays translated text strings for a number of text strings displayed on screen 300. In one implementation, all the text strings associated with the active dialog box 302, including the text strings on tab 304, text string 308 and the text strings on all the buttons, e.g. button 306, are translated when a user performs a predetermined action. In other implementations, translations of all of the text strings displayed on screen 300, including the inactive tabs and buttons, are displayed when a user performs a predetermined action.

In some embodiments, a translation application may be programmed to automatically display translations of text strings, without any action by a user. For example, in some embodiments all of the Hindi text strings displayed on screen 300 will be followed by translated English text strings. The foregoing are only some examples of different ways in which a translation application, according to embodiments of the present invention, may present translated text strings, and others will be apparent to those of ordinary skill in the art.

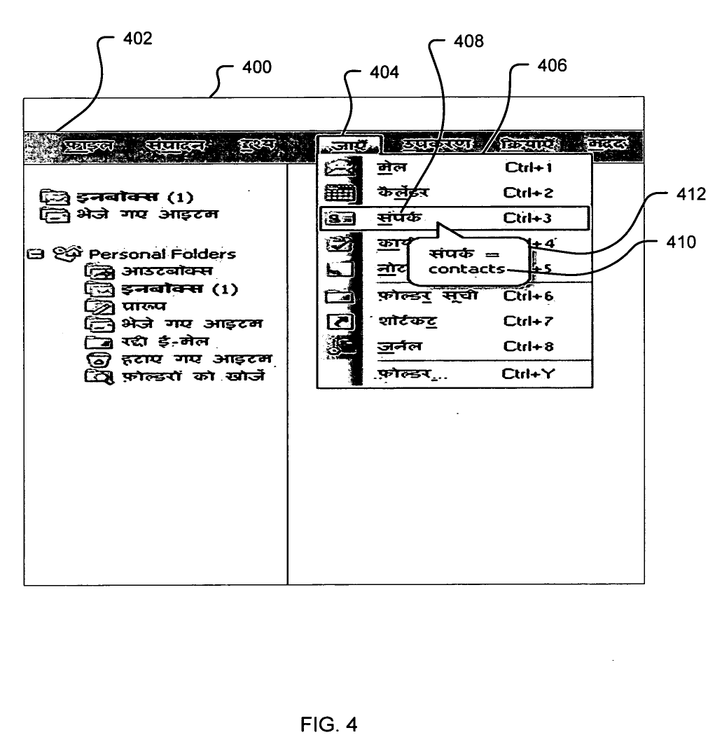

FIG. 4 illustrates a screen 400 showing a menu with Hindi text strings, one of which is translated into English according to one embodiment of the present invention. Screen 400 is displayed by a UI application, which in FIG. 4 is an electronic mail application. The UI application is localized in Hindi, and thus displays text strings in Hindi. Screen 400 shows a task bar 402 with a number of text strings, each of which may be selected by a user to display a menu. Text string 404 has been selected by a user, which displays menu 406. Menu 406 displays a list of Hindi text strings associated with tasks, or sub-menus, that may be selected by a user. In FIG. 4, a user has highlighted Hindi text string 408 on menu 406.

Similar to the embodiment described above with respect to FIG. 3, a user may translate any of the text strings displayed on screen 400 into a pre-selected target language. In the embodiment shown in FIG. 4, a user has selected to have the text strings translated from Hindi to English. When a user wants to have a specific text string translated, the user simply moves a pointer with a mouse to hover on or near the text string to translate. In FIG. 4, a user has hovered a pointer on or near text string 408. As a result, a translator application, according to an embodiment of the present invention, has translated text string 408 from Hindi to English, and displayed the English text string 410 in pop-up box 412. In the embodiment shown in FIG. 4, pop-up box 412 displays the Hindi text string 408 first, followed by an equal sign and then English text string 410. In other embodiments, the translator application may simply display the English text string 410 in pop-up box 412.

FIGS. 3 and 4 illustrate some screens for displaying translated text strings according to some embodiments of the present invention. It should be understood that the present invention is not limited to the embodiments illustrated in FIGS. 3 and 4, or the alternative embodiments discussed above.

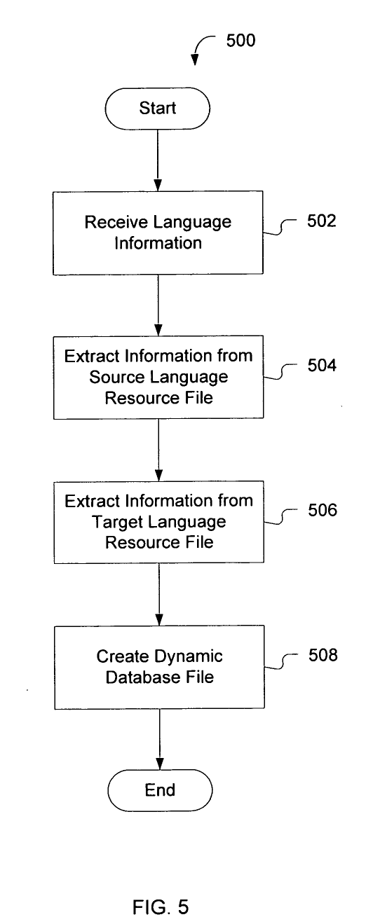

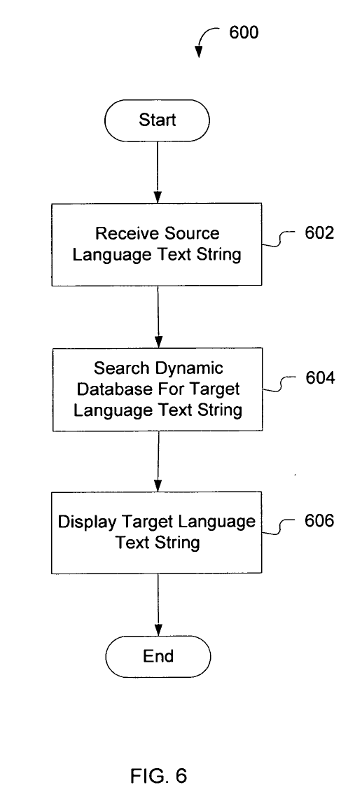

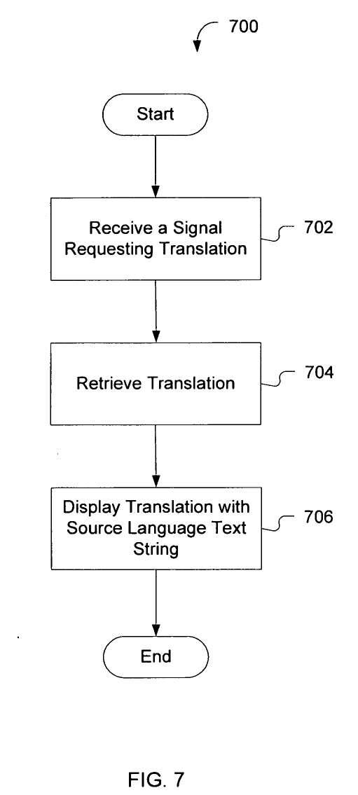

FIGS. 5, 6 and 7 illustrate operational flows 500, 600 and 700, respectively according to embodiments of the present invention. Operational flows 500, 600 and 700 may be performed in any suitable environment. For example, they may be executed by an application such as UI translator 112 (FIG. 1). Therefore, the description of operational flows 500, 600 and 700 may refer to at least one of the components of FIG. 1. However, any such reference to components of FIG. 1 is for descriptive purposes only, and it is to be understood that the implementations of FIG. 1 are a non-limiting environment for operational flows 500, 600 and 700.

Operational flow 500 illustrates a process for generating a dynamic database file mapping source language text strings to target language text strings, according to one embodiment of the present invention. At a operation 502, language information is received. By language information it is meant information indicating a source language in which text strings are displayed by a UI application, such as UI application 102 (FIG. 1) and a target language for translating the source language text strings to. In one embodiment, an application such as UI translator 112 (FIG. 1) is used to receive the language information. UI translator 112 may provide for allowing a user to input the source language and target language, such as by selecting a source language and a target language from a list of languages supported by UI translator 112. In other embodiments, UI translator may automatically retrieve the source language information from UI application 102 and provide a user interface to allow a user to input target language information.

At operation 504, information is extracted from a source language resource file. As previously described, a resource file includes information used by UI application 102 to be localized in a particular language. The resource files are installed when UI application 102 is installed, and include those portions of UI application 102 that are localized, such as text strings displayed by UI application 102 on menus, dialog boxes, and buttons. Examples of resource files are described above with respect to DLLs 104, 106, 108, and 110 (FIG. 1). In some implementations, UI translator 112 may be programmed to identify the location where the installed resource files are stored. In other embodiments, UI translator 112 may provide a user interface to allow a user to identify the location of resource files. The source language resource file is the resource file with the information for localizing the UI application in the source language.

When extracting information from the source language resource file, at least the source language text strings are extracted from the source language resource file. In other embodiments, the source language text strings are associated with resource ID numbers, which are also extracted from the source language resource file.

At operation 506, target language information is extracted from a target language resource file. The target language resource file includes information used by UI application 102 to localize UI application 102 in the target language. When extracting information from the target language resource file, at least the target language text strings are extracted from the target language resource file. In some embodiments, the target language text strings are associated with resource ID numbers, which are also extracted from the target language resource file.

At operation 508, a dynamic database file is created. The dynamic database file includes a mapping of source language text strings to target language text strings. The dynamic database is created using the extracted information from the source language resource file and the target language resource file. In one embodiment, the dynamic database file is created by “dumping,” i.e., storing, the source language information and the target language information extracted at operations 504 and 506 respectively, into a file. The information is then sorted to associate the source language text strings with the target language text strings.

In one embodiment, the sorting and associating is performed using resource ID numbers. In this embodiment, UI application 102 uses resource ID numbers to identify specific text strings, within resource files used to localize the application. The resource ID numbers are used to identify the text strings displayed by UI application 102. Accordingly, in each resource file there will be text strings with the same meaning, although in different languages, associated with the same resource ID number. For example, resource ID number 1 may be associated with the text string “Contacts.” Accordingly, in each resource file, resource ID number 1 will be associated with a text string that has the same meaning as “Contacts.” In implementing this embodiment, the dynamic database file is created by associating the source language text string identified with resource ID number 1 with the target language text string identified by resource ID number 1.

In one embodiment, dynamic database file is a simple text file that has resource ID numbers, source language text strings, and corresponding target language text strings. In other embodiments, the dynamic database file may be in any other suitable file formats.

Operational flow 600 illustrates a process for translating source language text strings to target language text strings, according to one embodiment of the present invention. At operation 602, a source language text string is received. The text string is originally displayed by a user interface application, such as UI application 102 (FIG. 1). In an embodiment, a user of UI application 102 performs an action that results in the text string being received by an application, such as UI translator 112 (FIG. 1). The retrieving of the text string may include capturing and sending the string by UI application 102 to UI translator 112. In other embodiments, the UI translator 112 captures and receives the text string. As those with skill in the art will appreciate, the capturing of text strings displayed on a screen may be facilitated by the operating system within which UI application 102 and UI translator 112 are operating. For example, in some “WINDOWS®” brand of operating systems, capturing displayed text is facilitated using the IAccessible interface.

At operation 604, a dynamic database is searched for a target language text string corresponding to the source language text string received at operation 602. In some embodiments, the dynamic database may be created by operational flow 500 described above, although in other embodiments it may be created using a different process.

The structure of the dynamic database will determine the method by which the database is searched. For example, in some embodiments, the dynamic database will include resource ID numbers, source language text strings and target language text strings. In this embodiment, the database may be searched by identifying the resource ID number associated with the source language text string to be translated. The resource ID number may then be used to retrieve the corresponding target language text string, which is stored in association with the resource ID number. In other embodiments, a database may have a direct mapping of source language text strings to target language text strings. Thus, when the source language text string is found within the dynamic database it is stored in association with the corresponding target language text string which is retrieved.

The target language text string is displayed at operation 606. As previously stated, UI translator 112 may display the target language text string in a number of ways. For example, the target language text string may be displayed in a pop-up box such as pop-up boxes 312 and 412 as described above with respect to FIG. 3 and FIG. 4. In other embodiments, the target language text string may replace the source language text string. As will be apparent to those of ordinary skill in the art, the method by which the target language text string is displayed is a matter of design choice and preference.

Operational flow 700 illustrates a process for displaying a source language text string with a translation (in a target language) of the source language text string. At operation 702, a signal is received indicating a request to translate a source language text string. The signal may be generated as a result of a user, interfacing with the UI application 102, performing some action such as clicking a button on a mouse, pressing keys on a keyboard, or hovering a pointer over the source language text string. The signal includes information regarding the source language text string to be translated. In an embodiment, the source language text string to be translated is captured, and sent in the signal requesting the translation.

At operation 704, a translation for the source language text string is retrieved. In one embodiment, the translation is retrieved from a dynamic database, such as dynamic database 114, mapping source language text strings to translations. In other embodiments, however, the translation may be performed by translation software that parses the source language text string and translates individual words that comprise the source language text string. For example, if the source language text string is “Personal Contacts,” the translation may include translating the terms “personal” and “contacts” individually using translation software. The translation software may include a database that associates words in one language with words of the same or similar meanings in a second language, similar to a dictionary. Accordingly, translating the words of the source language text string may simply involve retrieving translations, which are stored within a database, of the individual words that make up the text string. The foregoing are merely some examples, and retrieving a translation is not limited to these examples. In other embodiments the translation may be performed using other methods.

At operation 706, the translation retrieved at operation 704 is displayed with the source language text string. The phrase “displayed with” is intended to mean that both the translation and the source language text string are displayed to a user. In some embodiments, the translation may be displayed within a pop-up box, such as pop-up boxes 312 and 412 described and illustrated with respect to FIGS. 3 and 4. In some implementations of these embodiments, the source language text string is displayed by the user interface application; accordingly the translation and the source language text string are both being displayed to a user, the translation in a pop-up box and the text string by the user interface application. In other embodiments, both the translation and the source language text string are displayed within a pop-up box. In yet other embodiment, the translation is not displayed in a pop-up box, but is displayed adjacent or in proximity to the source language text string. In addition to these embodiments, the translation and the source language text string may be displayed to a user concurrently in other ways.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A method of translating a source language text string displayed by a user interface application into a target language text string, the method comprising:
receiving the source language text string;
searching a dynamic database file to retrieve the target language text string, wherein the dynamic database file comprises a mapping of source language text strings to corresponding target language text strings; and
displaying the target language text string.

2. The method of claim 1, further comprising:
prior to the receiving the source language text string, receiving language information regarding the source language and target language to identify a source language resource file and a target language resource file;
extracting the source language text strings from the source language resource file;
extracting the target language text strings from the target language resource file; and
creating the dynamic database file by mapping the source language text strings to the target language text strings.

3. The method of claim 2, wherein the source language resource file and the target language resource file are in the form of dynamic link libraries.

4. The method of claim 1, wherein the searching comprises:
identifying a resource ID number associated with the source language text string, and
using the resource ID number to identify the target language text string.

5. The method of claim 1, wherein the target language text string is displayed in a pop-up box.

6. The method of claim 5, wherein the source language text string is also displayed within the pop-up box.

7. The method of claim 1, wherein the user interface application displays the source language text string during the displaying the target language text string.

8. The method of claim 1, wherein the method is performed as a result of an action performed by a user.

9. The method of claim 8, wherein the action comprises hovering a pointer near the source language text string.

10. A computer-readable medium having computer executable instructions for performing steps comprising:
extracting a plurality of source language text strings from a source language resource file;
extracting a plurality of target language text strings from a target language resource file;
creating a dynamic database file by mapping each of the plurality of source language text strings to each of the plurality of target language text strings;
receiving a source language text string to translate;
searching the dynamic database file to retrieve a target language text string mapped to the source language text string to translate; and
displaying the target language text string as a translation of the source language text string to translate.

11. The computer-readable medium of claim 10 having further computer-executable instructions for performing the steps of:
prior to the extracting the plurality of source language text string, receiving language information regarding a source language and a target language to identify the source language resource file and the target language resource file.

12. The computer-readable medium of claim 10, wherein the source language text string to translate is displayed by a user interface application prior to the receiving the source language text string.

13. The computer-readable medium of claim 12, wherein the source language resource file is used by the user interface application to localize the user interface application in the source language.

14. The computer-readable medium of claim 13, wherein the target language resource file is used by the user interface application to localize the user interface application in the target language.

15. The computer-readable medium of claim 10, wherein the creating the dynamic database file comprises using resource ID numbers associated with the plurality of source language text strings and the plurality of target language text strings, to map each of the plurality of source language text strings to each of the plurality of target language text strings.

16. The computer-readable medium of claim 12, wherein the source language text string is displayed by the user interface application during the displaying the target language text string.

17. A method of displaying a translation of a source language text string displayed by a user interface application, the method comprising:
receiving a signal indicative of a request to translate the source language text string displayed by the user interface application;
retrieving a translation for the source language text string; and
displaying the translation with the source language text string.

18. The method of claim 17, wherein the translation is retrieved from a dynamic database file mapping source language text strings to translations.

19. The method of claim 17, wherein the translation is displayed within a pop-up box on the display.

20. The method of claim 19, wherein the source language text string is also displayed within the pop-up box.
